(19) United States
(12) Patent Application Publication
(10) Pub. No.: US 2011/0311175 A1
(43) Pub. Date: Dec. 22, 2011

(54) Oscillating Ball Bearing

(75) Inventors: Frank J. Damato, Keene, NH (US); Edward W. Jarvis, Swanzey, NH (US); Paul J. Carabello, Dublin, NH (US)

(73) Assignee: THE TIMKEN COMPANY, Canton, OH (US)

(21) Appl. No.: 13/146,275

(22) PCT Filed: Jan. 28, 2010
(86) PCT No.: PCT/US10/22377

§ 371 Date: Jul. 26, 2011

Related U.S. Application Data
(60) Provisional application No. 61/147,817, filed on Jan. 28, 2009.

(51) Int. Cl. F16C 19/20; F16C 19/06

(52) U.S. Cl. 384/521

(57) ABSTRACT

An angular contact or oscillating ball bearing (100) in which each ball or rolling element (102) is separated by a friction-reducing toroid spacer (103), which has low starting and miming friction, and which maintains a high degree of precision over an operational lifespan. Within the angular contact or oscillating bearing (100), each toroid spacer (103), disposed about alternate balls or rolling elements (102), is configured with sufficient clearance to allow free low-torque movement of the balls or rolling elements (102), and to minimize wear. The inner ring element (101a) of the bearing (100) includes an inner raceway (105a) disposed between a full shoulder side (109) and a low shoulder or relieved side (107), while the outer ring element (101b) includes an outer raceway (105b) disposed between a pair of full shoulder sides (110a, 110b). Both the inner ring element (101a) and the outer ring element (101b) surfaces are finished to minimize abrasion and wear of the toroid spacers (103). Annular shield elements (104) or seals secured to either the outer ring (101b) or inner ring (101a) element exclude foreign debris from entering the bearing, and retain any generated particles within the bearing internal regions, protecting an end use component in which the bearing (100) is assembled.

### CROSS-REFERENCE TO RELATED APPLICATIONS

The present application is related to, and claims priority from, U.S. Provisional Patent Application Ser. No. 61/147,817 filed on Jan. 28, 2009, and which is herein incorporated by reference.

### STATEMENT REGARDING FEDERALLY SPONSORED RESEARCH

Not Applicable.

### BACKGROUND OF THE INVENTION

The present invention relates generally to angular contact bearings, and in particular, to a high-precision oscillating ball bearing with low starting and running friction.

The current practice for “low friction” and “low out-gassing” angular contact ball bearings is to specify an angular contact ball bearing (ACBB) design with PTFE toroids (small toroidal or “doughnut” shaped pieces) around every other ball element to separate the balls within the bearing structure. These PTFE toroids can wear during operation with current designs, creating higher friction between the balls and components of the bearing structure. Similarly, unshielded bearings can allow contaminants to enter the bearing structure, also creating higher friction. In an exemplary application, high-precision bearings are required for encoder applications, and must have both a low starting and a low running friction which remains very consistent for the entire operating life of the bearing, so that adequate encoder resolution for the entire application lifespan can be met.

Accordingly, it would be advantageous to provide an angular contact or oscillating ball bearing in which each ball or rolling element is separated by a friction-reducing spacer, which has low starting and running friction, and which maintains a high degree of precision over an operational lifespan of the bearing.

### BRIEF SUMMARY OF THE INVENTION

Briefly stated, the present disclosure provides an angular contact or oscillating bearing in which each ball or rolling element is separated by a friction-reducing toroid spacer, which has low starting and running friction, and which maintains a high degree of precision over an operational lifespan. Within the angular contact or oscillating bearing, each toroid spacer, disposed about an alternate balls or rolling elements, is configured with sufficient clearance to allow free, low-torque movement of the balls or rolling elements, and to minimize wear. The inner ring element of the angular contact or oscillating bearing includes an inner raceway disposed between a full shoulder side and a low shoulder or relieved side, while the outer ring element includes an outer raceway disposed between a pair of full shoulder sides. Both the inner ring element and the outer ring element surfaces are finished to minimize abrasion and wear of the toroid spacers. Annular shield elements secured to the one of the ring elements exclude foreign debris from entering the bearing, and retain any generated particles within the angular contact or oscillating bearing, protecting the end use components in which the angular contact or oscillating bearing is assembled.

In an alternative embodiment, annular shield elements secured to one of the ring elements of the angular contact or oscillating bearing as described above are replaced by annular seal elements mounted to either the inner or outer ring, on opposite sides of the balls or rolling elements, and which are in sliding contact with the ring surfaces opposite from their mounting element.

In an alternative embodiment of the of the angular contact or oscillating bearing, the annular shield elements described above are excluded, and the angular contact or oscillating bearing remains open on either side of the balls or rolling elements.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an axial end view of the angular contact or oscillating bearing;

FIG. 2 is cross-section view of the angular contact or oscillating bearing shown in FIG. 1;

FIG. 3 is an enlarged cross-section view of the angular contact or oscillating bearing of the present disclosure;

FIG. 4 is an axially directed view as shown in A-A in FIG. 3.

FIG. 5A is an enlarged cross-section view of a rolling element separation toroid having rounded corners;

FIG. 5B is an enlarged cross-section view of a rolling element separation toroid having tapered corners;

FIG. 6 is a sectional view of an inner race of the angular contact or oscillating bearing; and

FIG. 7 is a sectional view of an outer race of the angular contact or oscillating bearing.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

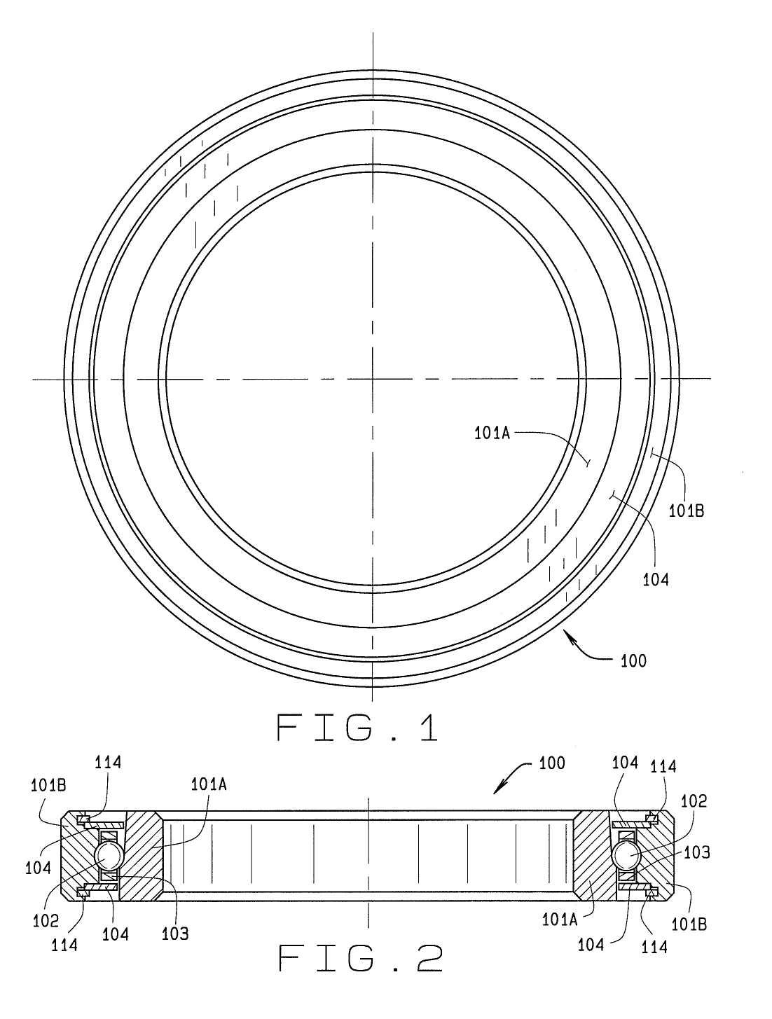

Turning to the Figures, and to FIGS. 1-3 in particular, an angular contact or oscillating bearing of the present disclosure, configured for low friction and high precision operation is shown generally at 100. The angular contact or oscillating bearing 100 is configured with an inner race 101a, an outer race 101b, a set of balls or rolling elements 102, PTFE composite toroid ball separators 103, clean instrument grade oil lubricant, and optional closures 104 to keep internal bearing particles inside the bearing 100, and external environmental particles outside the bearing 100.

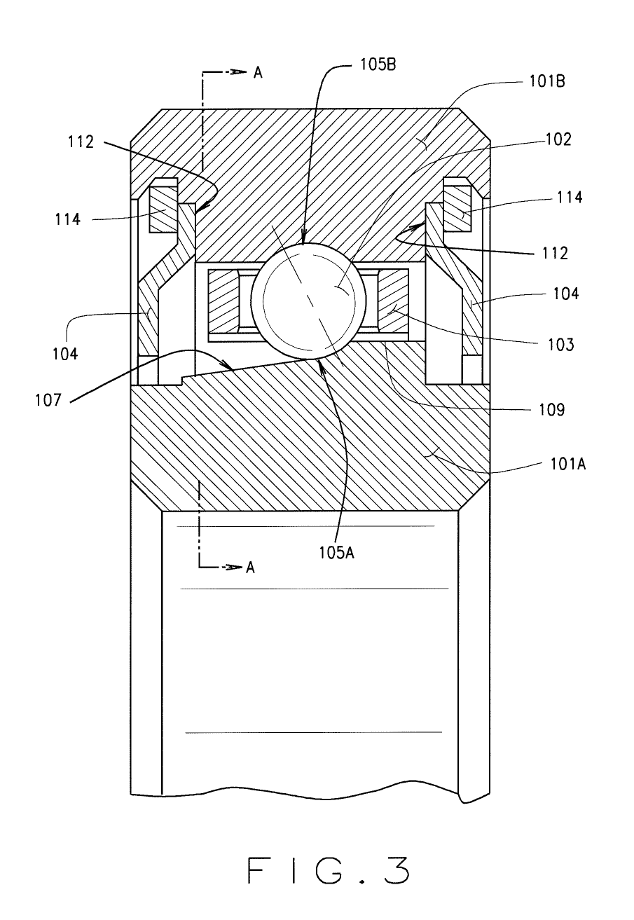

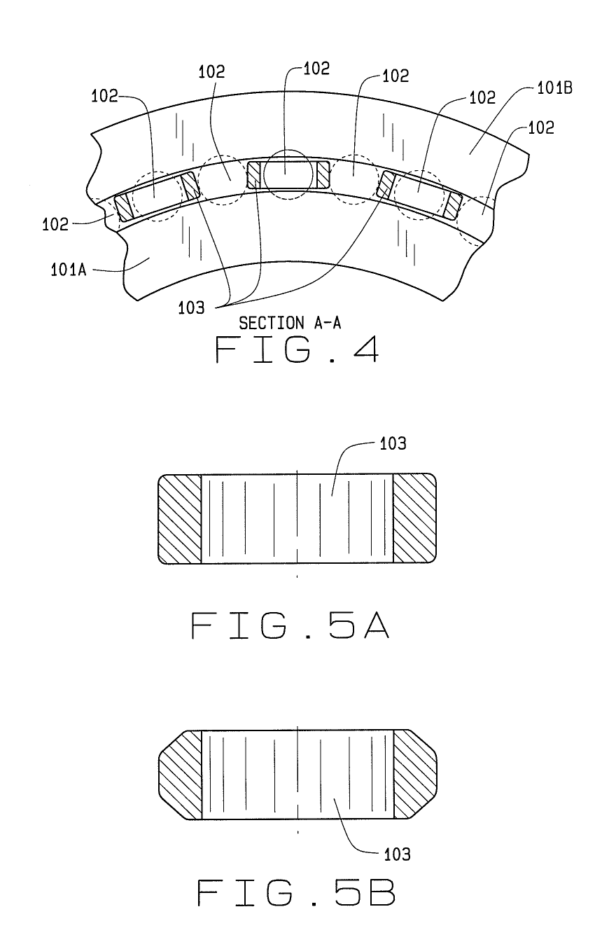

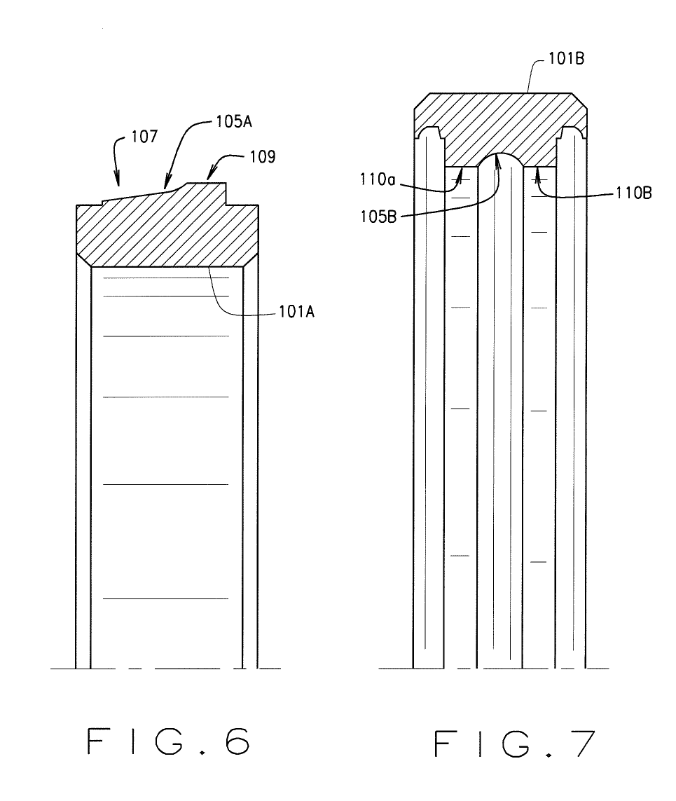

The bearing 100 is configured with several features to facilitate the low friction and high precision operation. As is best seen in FIG. 3, the bearing 100 consists generally of a plurality of balls or rolling elements 102 disposed between an inner raceway 105a on an outer diameter of the inner ring or race 101a, and an outer raceway 105b on an inner diameter of the outer ring or race 101b. To minimize wear of the rolling elements 102, a plurality of friction-reducing toroid spacers 103 are disposed about each alternating ball or rolling element 102, and are configured with sufficient clearance to allow for low-torque movement of the balls or rolling elements 102, as best seen in FIGS. 4 and 5A, 5B. To accommodate movement of the toroid spacers 103 during oscillating movement of the bearing 100, the inner ring 101a is provided with a low shoulder or relieved shoulder 107 on one side of the inner raceway 105a, and a full shoulder 109 on the opposite side of the inner raceway 105a. The outer ring element 101b outer raceway 105b is disposed between a pair of full shoulder sides 110a, 110b. The corners of each raceway 105a, 105b are processed to remove any raised ring material. To further minimize abrasion and wear of the toroid spacers 103 during operation of the angular contact or oscillating bearing 100, both the inner ring element 101 a and the outer ring element 101 b shoulder surfaces 107, 109, 110a, and 110b are provided with finished surfaces, such as by grinding, tumbling, or polishing.

During operation of the angular contact or oscillating bearing 100, bearing rotation creates centrifugal acceleration that acts upon each toroid spacer 103, causing each to predominately contact the outer ring 101a during operation. Effectively, the concave surfaces of the shoulders 110a and 110b on the inner diameter of the outer ring 101a guide the sides of the toroid spacers 103 near each toroid spacer's outer diameter, and provide increased surface area and support for the toroids 103 during rotation of the angular contact or oscillating bearing 100.

As best seen in FIGS. 5A and 5B, each toroid spacer 103 is generally configures as a short cylinder, and is placed around a rolling element 102 contained between the inner raceway 105a and outer raceway 105b. Each toroid spacer 103 is configured with minimum clearances to reduce unplanned movement, as well as to prevent binding or interference with the inner ring 101a, outer ring 101b, balls or rolling elements 102, or any adjacent bearing shields or seals 104. In one embodiment, as shown in FIG. 5A, the outer diameter corners of each toroid spacer 103 are radiused, chamfered, or blended to minimize stress concentration from contact with adjacent ring surfaces or rolling elements 102 during use. In an alternative configuration, as shown in FIG. 5B, the side faces of the cylindrical toroid spacers 103 are tapered to match the curvature of the mating inner diameter of the outer ring shoulder surfaces 110a and 110b.

Preferably, the toroid spacers 103 are formed from material which is economical to manufacture by machining or molding, which is compatible with various environmental conditions in which the angular contact or oscillating bearing 100 may be utilized (i.e., steam/wet/dry/vacuum), and which has favorable out gassing properties. In one embodiment, the toroid spacers 103 are formed in a conventional manner from PTFE, a material with a low coefficient of friction because of a tendency to lubricate adjacent surfaces by smearing.

However, it has been found that the toroid contact areas within the bearing assembly 100 of the present disclosure are small, and pressure between the material of the toroids 103 and the bearing ring surfaces 109, 110a, and 110b may exceed the pressure velocity rating of pure PTFE material (˜1000), resulting in excessive wear and particle generation within the bearing assembly 100.

Accordingly, it is preferred that the toroid spacers 103 be formed from a material having a greater pressure velocity rating of pure PTFE material, and with a pressure velocity rating generally exceeding 10,000.

In one embodiment, the material of the toroid spacers 103 is a blend of PTFE and approximately 15% graphite/carbon filler. Other toroid materials could also be acceptable, such as PAI (Torlon® or equivalent) either unfilled or preferably with internal lubricants of graphite and/or fluoropolymers, PPS (Techtron HPV PPS® or equivalent) either unfilled or preferably with internal lubricants and fillers, or PI (Vesper) or equivalent) either unfilled or preferably with internal lubricants of graphite and/or fluoropolymers. To prevent entry of external debris into the angular contact or oscillating bearing 100, and to prevent bearing oil and wear particles from exiting the bearing assembly 100, one embodiment of the present disclosure incorporates a pair of annular shield elements 104 disposed on opposite axial sides of the be rolling elements 102 and toroids 103. Shields 104 are defined as closure elements, either removable or permanently installed, that are mounted to one ring (for example but not limited to the outer ring 101b) but do not contact the other ring (for example but not limited to the inner ring 101a). As shown in FIG. 3, the shields 104 may be retained within a suitable annular recess 112 on the inner diameter of the outer ring element 101a by a retaining clip, wire, or snap ring 114. In an alternate configuration, the shields 104 are replaced by seals (not shown). Seals are defined as closures, removable or permanently installed, that are mounted to one ring (for example but not limited to the outer ring 101b) and also have rubbing or sliding contact with the other ring (for example but not limited to the inner ring 101a). Finally, in some applications, it may be desirable to provide an open bearing wherein no closure in the form of either shields 104 or seals is provided.

As various changes could be made in the above constructions without departing from the scope of the disclosure, it is intended that all matter contained in the above description or shown in the accompanying drawings shall be interpreted as illustrative and not in a limiting sense.

1. An angular contact or oscillating bearing (100) having a plurality of rolling elements (102) disposed between an inner raceway (105a) on an outer diameter of an inner ring or race element (101a), and an outer raceway (105b) on an inner diameter of an outer ring or race element (101b), comprising:
a plurality of friction-reducing toroid spacers (103), each toroid spacer (103) disposed about an alternating rolling element (102) and configured with sufficient clearance to allow low-torque movement of the rolling elements (102), and to minimize wear;
wherein the inner ring element inner raceway (105a) is disposed between a full shoulder side (109) and a low shoulder side (107), said low shoulder side (107) having an outer diameter which is smaller than an outer diameter of said full shoulder side (109) to accommodate movement of the toroid spacers during oscillating movement of the bearing; and
wherein the outer ring element outer raceway (105b) is disposed between a pair of full shoulder surfaces (110a, 110b), each of said full shoulder surfaces in supporting contact with said plurality of friction-reducing toroid spacers during rotational movement of said bearing.

2. The angular contact or oscillating bearing (100) of claim 1 wherein both the inner ring or race element (101a) and the outer ring or race element (101b) shoulder surfaces (107, 109, 110a, 110b) have a surface finish to minimize abrasion and wear of the toroid spacers (103) during rotational movement.

3. The angular contact or oscillating bearing (100) of claim 2 wherein said inner ring or race element shoulder surface finishes and said outer ring or race element shoulder surface finishes are formed by a process selected from a set of processes including grinding, tumbling, and polishing.

4. The angular contact or oscillating bearing (100) of claim 1 wherein said rolling elements (102) are balls.

5. The angular contact or oscillating bearing (100) of claim 1 further including a first annular shield element (104) secured adjacent a first axial side of the rolling elements (102); and
a second annular shield element (104) secured adjacent a second axial side of the rolling elements (102);
wherein said first and second annular shield elements (104) are configured to exclude foreign debris from entering the angular contact or oscillating bearing (100), and to retain any generated particles within the internal regions of the angular contact or oscillating bearing (100), protecting an end use component in which the angular contact or oscillating bearing (100) is assembled.

6. The angular contact or oscillating bearing (100) of claim 1 further including a first annular seal element secured adjacent a first axial side of the rolling elements (102); and
a second annular seal element secured adjacent a second axial side of the rolling elements (102);
wherein said first and second annular seal elements are configured to exclude foreign debris from entering the angular contact or oscillating bearing (100), and to retain any generated particles within the internal regions of the angular contact or oscillating bearing (100), protecting an end use component in which the angular contact or oscillating bearing (100) is assembled.

7. The angular contact or oscillating bearing (100) of claim 1 where each toroid spacer (103) is configured with a cylindrical body having rounded or blended outer diameter corners.

8. The angular contact or oscillating bearing (100) of claim 1 where each toroid spacer (103) is configured with a cylindrical body having tapered outer diameter corners tapered to match a curvature of the outer ring full shoulder surfaces.

9. The angular contact or oscillating bearing (100) of claim 1 where each toroid spacer (103) is composed at least partially of a material selected from a set of materials including PTFE, PAI, PPS, or Pl.

10. The angular contact or oscillating bearing (100) of claim 1 where each toroid spacer (103) is composed of a composition of PTFE and graphite/carbon filler.

11. The angular contact or oscillating bearing (100) of claim 10 wherein said graphite/carbon filler comprises approximately 15% of said composition of said toroid spacer (103).

12. The angular contact or oscillating bearing (100) of claim 1 wherein said low shoulder side (107) of said inner ring or race element (101a) is configured to support and guide said toroid spacers (103).

13. The angular contact or oscillating bearing of claim 1 wherein said low shoulder side (107) of said inner ring or race element (101a) is configured to slope axially outward and radially inward from said inner raceway (105a).

14. The angular contact or oscillating bearing of claim 1 wherein each toroid spacer (103) is composed of a composition having a pressure velocity rating exceeding 10,000.
